(19) United States
(12) Patent Application Publication
(10) Pub. No.: US 2008/0173267 A1
(43) Pub. Date: Jul. 24, 2008

(54) Valve timing control apparatus

(75) Inventors: Kinya Takahashi, Obu-city (JP); Masayasu Ushida, Okazaki-city (JP); Takao Nojiri, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/000,718

(22) Filed: Dec. 17, 2007

(30) Foreign Application Priority Data
Jan. 18, 2007 (JP) 2007-9149

(51) Int. Cl. F01L 1/34; F01L 1/047; B23Q 16/06

(52) U.S. Cl. 123/90.17; 123/90.31; 74/813 C

(57) ABSTRACT

A valve timing control apparatus controls a valve timing of intake/exhaust valve of an engine. The apparatus includes a housing rotated with a driving shaft. The housing has a chamber house accommodating a vane rotor rotative with a driven shaft to retard and advance sides relative to the housing by being exerted with hydraulic pressure in retard and advance chambers in the chamber house. A filter is provided for removing foreign matters in a fluid passage extending from a slidable portion between the driven shaft and a bearing toward both the housing and the vane rotor through a connected portion between the driven shaft and the vane rotor. The filter is provided on the side of both the housing and the vane rotor with respect to the slidable portion.

### CROSS REFERENCE TO RELATED APPLICATIONS

This application is based on and incorporates herein by reference Japanese Patent Application No. 2007-9149 filed on Jan. 18, 2007.

### FIELD OF THE INVENTION

The present invention relates to a valve timing control apparatus for controlling a valve timing as an opening-and-closing timing of at least one of an intake valve and an exhaust valve for an internal combustion engine.

### BACKGROUND OF THE INVENTION

For example, U.S. Pat. No. 7,182,052 B-2 (JP-A-2006-46315) proposes a valve timing control apparatus for controlling a phase of a camshaft relative to a crankshaft of an internal combustion engine. The valve timing control apparatus includes a housing and a vane rotor. The housing receives driving force of the crankshaft. The vane rotor is accommodated in the housing for transmitting the driving force from the crankshaft to the camshaft. The vane rotor is exerted with pressure of working fluid in the retard chamber and the advance chamber, thereby being rotated to the retard side and the advance side relative to the housing.

Here, foreign matters, such as burrs and machining powder may be produced in a machining work to form a hydraulic passage in an engine head and a camshaft. Such foreign matters are hard to be completely removed from the product even the product is washed after the machining. Furthermore, foreign matters such as burrs may be dropped into the interior of the engine from the valve timing control apparatus mounted to the engine. In addition, ablation powders may be produced in the course of ablation in a sliding portion, and may be mixed in working fluid.

In order to remove such foreign matters, it is conceived to provided a filter on the side of a hydraulic pump with respect to a selector valve such as an oil control valve (OCV). The OCV such as a solenoid spool valve is provided for changeover of a connection between the valve timing control apparatus and the passage. In this structure, the filter restricts foreign matters from intruding from the internal combustion engine into the OCV and the valve timing control apparatus. For example, JP-A-2001-173806 proposes a filter directly mounted to a port of an OCV.

However, in the structure of JP-A-2001-173806, foreign matters may be produced in a hydraulic passage between the OCV and the timing control apparatus, and such foreign matters cannot be removed using the filter. As a result, foreign matters intruding into the valve timing control apparatus may cause a malfunction and anomalous ablation in a slidable portion of the valve timing control apparatus.

### SUMMARY OF THE INVENTION

In view of the foregoing and other problems, it is an object of the present invention to produce a valve timing control apparatus having a slidable portion restricted from causing anomalous ablation and a malfunction.

According to one aspect of the present invention, a valve timing control apparatus provided in a driving force transmission system for transmitting driving force from a driving shaft of an internal combustion engine to a driven shaft for manipulating at least one of an intake valve and an exhaust valve, the apparatus being adapted to controlling an opening timing and a closing timing of at least one of the intake valve and the exhaust valve, the apparatus comprises a housing adapted to being rotated with one of the driving shaft and the driven shaft, the housing having a chamber house in a predetermined angle range relative to a rotative direction. The apparatus further comprises a vane rotor having a vane accommodated in the chamber house and partitioning the chamber house into a retard chamber and a advance chamber, the vane rotor being rotative in conjunction with an other of the driving shaft and the driven shaft to a retard side and an advance side relative to the housing by being exerted with hydraulic pressure in the retard chamber and the advance chamber. The apparatus further comprises a filter provided for removing foreign matters in a fluid passage. The fluid passage is adapted to leading hydraulic fluid from a slidable portion between the driven shaft and a bearing of the driven shaft to both the housing and the vane rotor through a connected portion between the driven shaft and one of the housing and the vane rotor. The filter is provided on a side of both the housing and the vane rotor with respect to the slidable portion.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a valve timing control apparatus in a retard angle operation, according to a first embodiment;

FIG. 2 is a sectional view showing the valve timing control apparatus;

FIG. 3 is a view showing the valve timing control apparatus, from which a front plate is removed, and the view being viewed from the arrow III in FIG. 2;

FIG. 4 is a front view showing a filter according to the first embodiment;

FIG. 5 is a front view showing a filter according to a modification of the first embodiment;

FIG. 6 is a schematic view showing the valve timing control apparatus in an advance angle operation, according to the first embodiment;

FIG. 7 is a schematic view showing the valve timing control apparatus in an intermediate holding operation, according to the first embodiment;

FIGS. 8A to 8D are sectional views each showing an operation of a first check valve and a first control valve of the valve timing control apparatus according to the first embodiment;

FIGS. 9A to 9D are sectional views each showing an operation of a second check valve and a second control valve of the valve timing control apparatus according to the first embodiment;

FIG. 10 is a graph showing a relationship between a phase and a time in the advance operation of the valve timing control apparatus;

FIG. 11 is a view showing a filter when being viewed from the camshaft, according to the second embodiment; and

FIG. 12A is a sectional view showing the filter, and FIG. 12B is an enlarged front view showing the filter, according to the second embodiment.

### DETAILED DESCRIPTION OF PREFERRED EMBODIMENTS

### First Embodiment

A valve timing control apparatus 1 of the present embodiment is a hydraulic-pressure controlled apparatus for controlling a valve timing of an intake valve by using a working fluid as a hydraulic fluid.

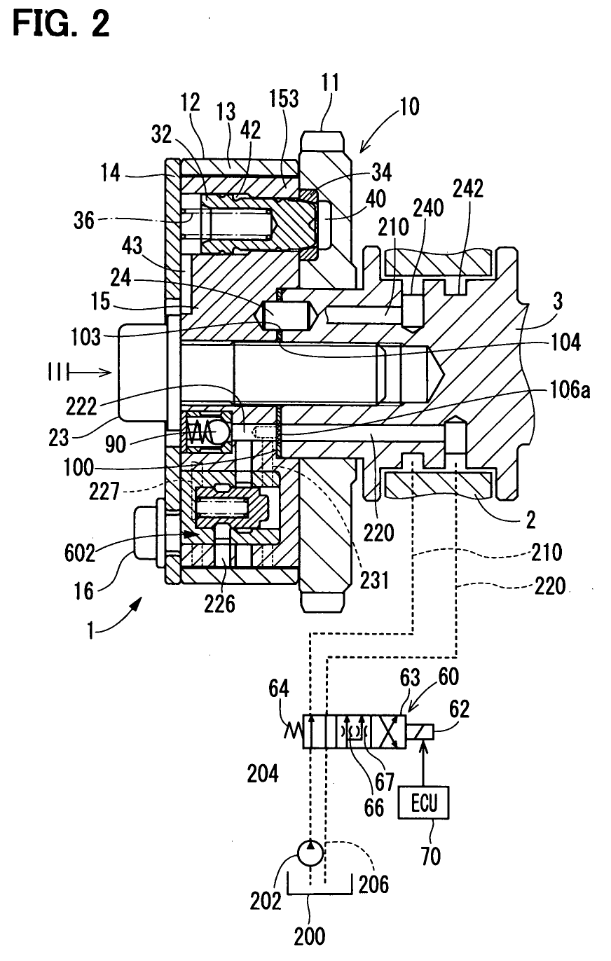

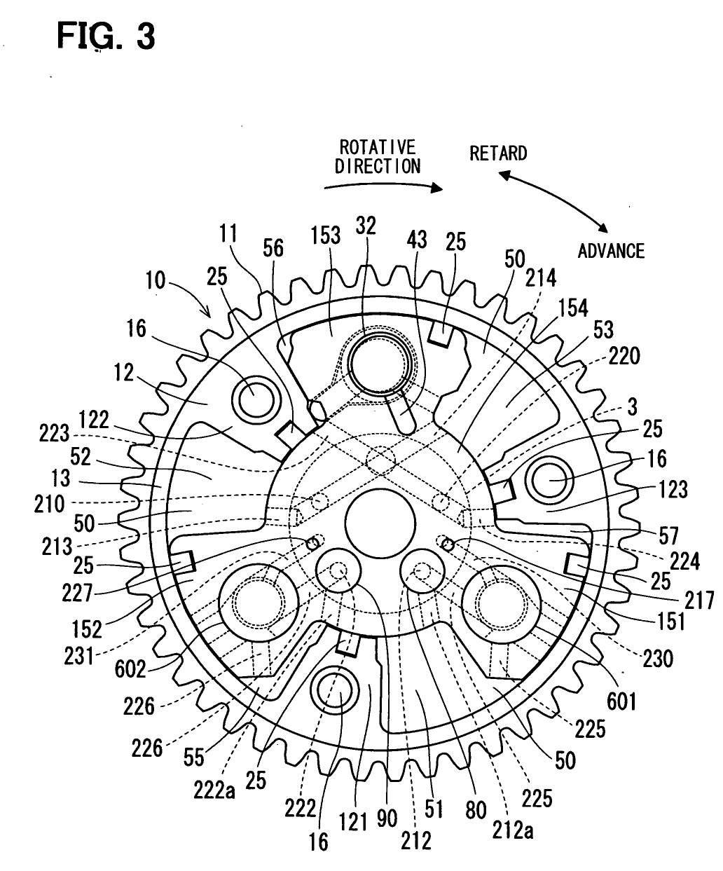

As shown in FIG. 2, a housing 10 as a driving-side rotor includes a chain sprocket 11, a shoe housing 12, and a front plate 14. The shoe housing 12 has shoes 121, 122, 123 (FIG. 3) as partition members, and an annular peripheral wall 13. The front plate 14 is located on the opposite side of the chain sprocket 11 with respect to the peripheral wall 13, and is coaxially fixed on both the chain sprocket 11 the shoe housing 12 using bolts 16. The chain sprocket 11 joins with a crankshaft as a driving shaft of the internal combustion engine (not shown) via a chain (not shown), thereby being transmitted with driving force from the crankshaft, and rotated together with the crankshaft.

The driving force of the crankshaft is transmitted to a camshaft 3 as a driven shaft via the valve timing control apparatus 1, thereby the camshaft 3 opens and closes the intake valve (illustrated). The camshaft 3 is rotatable and is inserted to the chain sprocket 11 such that the camshaft 3 has a predetermined phase difference relative to the chain sprocket 11.

A vane rotor 15 as a driven rotor is in contact with the axial end surface of the camshaft 3. The camshaft 3 and the vane rotor 15 are coaxially joined and fixed using a bolt 23. A locator pin 24 is fitted into the vane rotor 15 and the camshaft 3, thereby positioning the vane rotor 15 relative to the camshaft 3 with respect to the rotative direction. The camshaft 3, the housing 10, and the vane rotor 15 rotate clockwise when being viewed from the arrow III in FIG. 2.

The rotative direction is defined as an advance direction of the camshaft 3 relative to the crankshaft.

As shown in FIG. 3, the shoes 121, 122, 123 being in a trapezoid shape are extended from the peripheral wall 13 toward the radially inner side, and are provided substantially at regular intervals relative to the rotative direction of the peripheral wall 13. The shoes 121, 122, 123 define gaps at three places with respect to the rotative direction, and each of the gaps has a predetermined angle range. The three gaps respectively correspond to three sector-shaped chamber houses 50 respectively accommodating vanes 151, 152, 153.

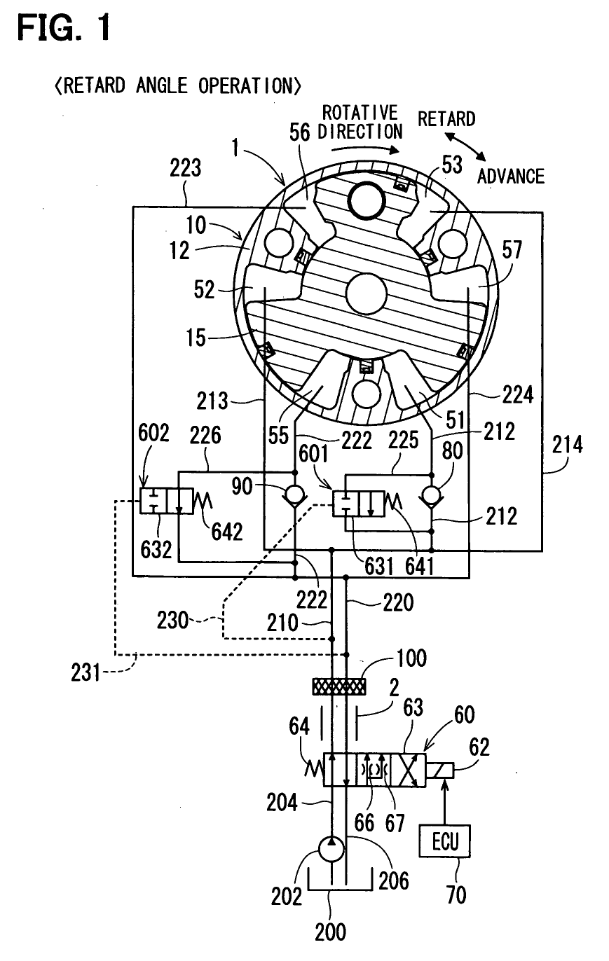

The vane rotor 15 includes a boss portion 154 joined with the camshaft 3 at an axial end surface. The vane rotor 15 further includes the vanes 151, 152, 153 provided to the outer periphery side of the boss portion 154 at substantially regular intervals with respect to the rotative direction. The vane rotor 15 is accommodated in the housing 10, and is rotatable relatively to the housing 10. The vanes 151, 152, 153 are rotatably accommodated respectively in the chamber houses 50. Each of the vanes 151, 152, 153 divides each chamber house 50, and partitions each chamber house 50 into a retard chamber and an advance chamber. Referring to FIG. 1, the arrows showing the retard and the advance respectively indicate the retard direction and the advance direction of the vane rotor 15 relative to the housing 10.

A sealing member 25 is provided in a sliding gap between each of the shoes 121, 122, 123 and the boss portion 154, which radially face to each other. The sealing member 25 is also provided in a sliding gap between each of the vanes 151, 152, 153 and the inner periphery of the peripheral wall 13, which radially face to each other. The sealing member 25 fits in a slot provided in the inner periphery of each shoe, and fits in a slot provided in the outer wall of each vane. Each sealing member 25 is biased toward the outer wall of the boss portion 154, or is biased toward the inner periphery of the peripheral wall 13 with a spring or the like. In the present structure, the sealing member 25 restricts the working fluid from therethrough leaking from one of the retard chamber and the advance chamber to the other of the retard chamber and the advance chamber.

As shown in FIG. 2, a stopper piston 32 as a cylindrical fitting member is accommodated in a through hole formed in the vane 153 such that the stopper piston 32 is movable in the axial direction. A fitting ring 34 is press-fitted and held in a recess formed in the chain sprocket 11. The stopper piston 32 can be fitted into the fitting ring 34 as a fitting hole. Both the stopper piston 32 and the fitting ring 34 have fitted faces being in tapered shapes, such that the stopper piston 32 is smoothly fitted into the fitting ring 34. A spring 36 as a biasing member applies load to the stopper piston 32 toward the fitting ring 34. The stopper piston 32, the fitting ring 34, and the spring 36 construct a restriction mechanism, which restricts rotation of the vane rotor 15 relative to the housing 10.

Working fluid is supplied into a hydraulic pressure chamber 40 formed in the chain sprocket 11 of the stopper piston 32 and a hydraulic pressure chamber 42 formed around the outer periphery of the stopper piston 32, and the working fluid applies pressure such that the stopper piston 32 slips out from the fitting ring 34. The hydraulic pressure chamber 40 communicates with an advance chamber 56. The hydraulic pressure chamber 42 communicates with a retard chamber 53. A tip end of the stopper piston 32 can be fitted into the fitting ring 34 when the vane rotor 15 is in a maximum retard position relative to the housing 10. Rotation of the vane rotor 15 is restricted relative to the housing 10 in a state where the stopper piston 32 is fitted into the fitting ring 34. The vane rotor 15 has a surface on the opposite side of the fitting ring 34 with respect to the stopper piston 32, and the surface has a back pressure vent groove 43 for releasing back pressure changed with sliding of the stopper piston 32.

When the vane rotor 15 rotates from the maximum retard position to the advance side relative to the housing 10, and the rotative position of the stopper piston 32 is shifted relative to the fitting ring 34, the stopper piston 32 cannot be fitted into the fitting ring 34.

As shown in FIG. 3, a retard chamber 51 is formed between the shoe 121 and the vane 151. A retard chamber 52 is formed between the shoe 122 and the vane 152. The retard chamber 53 is formed between the shoe 123 and the vane 153. An advance chamber 55 is formed between the shoe 121 and the vane 152. The advance chamber 56 is formed between the shoe 122 and the vane 153. The advance chamber 57 is formed between the shoe 123 and the vane 151.

Referring to FIG. 1, a hydraulic pump 202 as a fluid source pumps working fluid from an oil sump 200 to a supply passage 204. A phase select valve 60 is a known solenoid spool valve, and is provided to the hydraulic pump 202 on the side of a bearing 2. An electronic control unit (ECU) 70 controls a duty ratio of a driving current supplied to a solenoid actuator 62, thereby controlling the phase select valve 60. A spool 63 of the phase select valve 60 is displaced based on the duty ratio of the driving current. The phase select valve 60 switches supply of working fluid to each retard chamber and each advance chamber and drain of working fluid from each retard chamber and each advance chamber, in accordance with the position of the present spool 63. When the phase select valve 60 is de-energized, the spool 63 is in the position depicted in FIG. 1 by being applied with the load of a spring 64.

As shown in FIG. 2, the camshaft 3 is rotatably supported by the bearing 2, and the camshaft 3 has the outer wall defining annular passages 240, 242. A retard passage 210 extends from the phase select valve 60, and passes through the annular passage 240. An advance passage 220 extends from the phase select valve 60, and passes through the annular passage 242. The retard passage 210 and the advance passage 220 are formed inside of the camshaft 3 and the boss portion 154 of the vane rotor 15.

As shown in the FIG. 1, the retard passage 210 branches to retard passages 212, 213, 214 connected to the retard chambers 51, 52, 53. The retard passages 210, 212, 213, 214 drain working fluid from each retard chamber into the oil sump 200 on the drain side through the phase select valve 60 and a drain passage 206, and supplying working fluid from the oil sump 200 into each retard chamber through the supply passage 204 and the phase select valve 60. The retard passages 210, 212, 213, 214 serve as both a retard supply passage and a retard drain passage.

The advance passage 220 branches to advance passages 222, 223, 224 connected with the advance chambers 55, 56, 57. The advance passages 220, 222, 223, 224 drain working fluid from each advance chamber into the oil sump 200 on the drain side through the phase select valve 60 and the drain passage 206, and supplying working fluid from the oil sump 200 into each advance chamber through the supply passage 204 and the phase select valve 60. Therefore, the advance passages 220, 222, 223, 224 serve as both an advance supply passage and an advance drain passage.

In the passage structure, working fluid can be supplied from the hydraulic pump 202 into the retard chambers 51, 52, 53, the advance chambers 55, 56, 57, and the hydraulic pressure chambers 40 and 42. In addition, working fluid can be drained from each hydraulic pressure chamber to the oil sump 200. The retard passages 210, 212, 213, 214, the advance passages 220, 222, 223, 224, a retard pilot passage 230, and an advance pilot passage 231, a first drain passage 225, and a second drain passage 226 serve as a fluid passage.

A first check valve 80 is provided to the retard passage 212 among the retard passages 212, 213, 214 connected to the retard chambers 51, 52, 53. The first check valve 80 is provided to the retard passage 212 on the side of the retard chamber 51 with respect to the bearing 2. The retard chamber 51 serves as a check valve connection chamber. The first check valve 80 permits flowing of working fluid from the hydraulic pump 202 into the retard chamber 51 through the retard passage 212, and restricts flowing of working fluid backward from the retard chamber 51 into the hydraulic pump 202 through the retard passage 212. The retard chamber 51 is connected to the retard passage 212, which is provided with the first check valve 80, and the retard chamber 51 serves as a retard control chamber 51.

A second check valve 90 is provided to the advance passage 222 among the advance passages 222, 223, 224 connected with the advance chambers 55, 56, 57. The second check valve 90 is provided to the advance passage 222 on the side of the advance chamber 55 with respect to the bearing 2. The advance chamber 55 serves as a check valve connection chamber. The second check valve 90 permits flowing of working fluid from the hydraulic pump 202 into the advance chamber 55 through the advance passage 222, and restricts flowing of working fluid backward from the advance chamber 55 into the hydraulic pump 202 through the advance passage 222. The advance chamber 55 is connected with the advance passage 222, which is provided with the second check valve 90, and the advance chamber 55 serves as an advance control chamber 55.

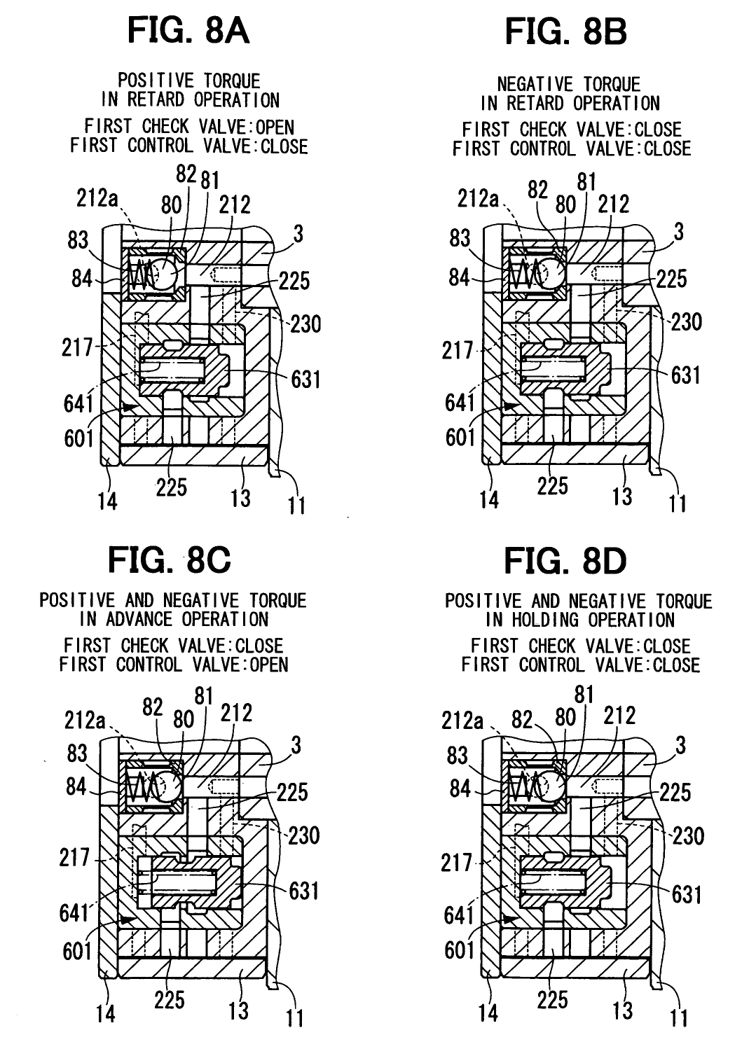

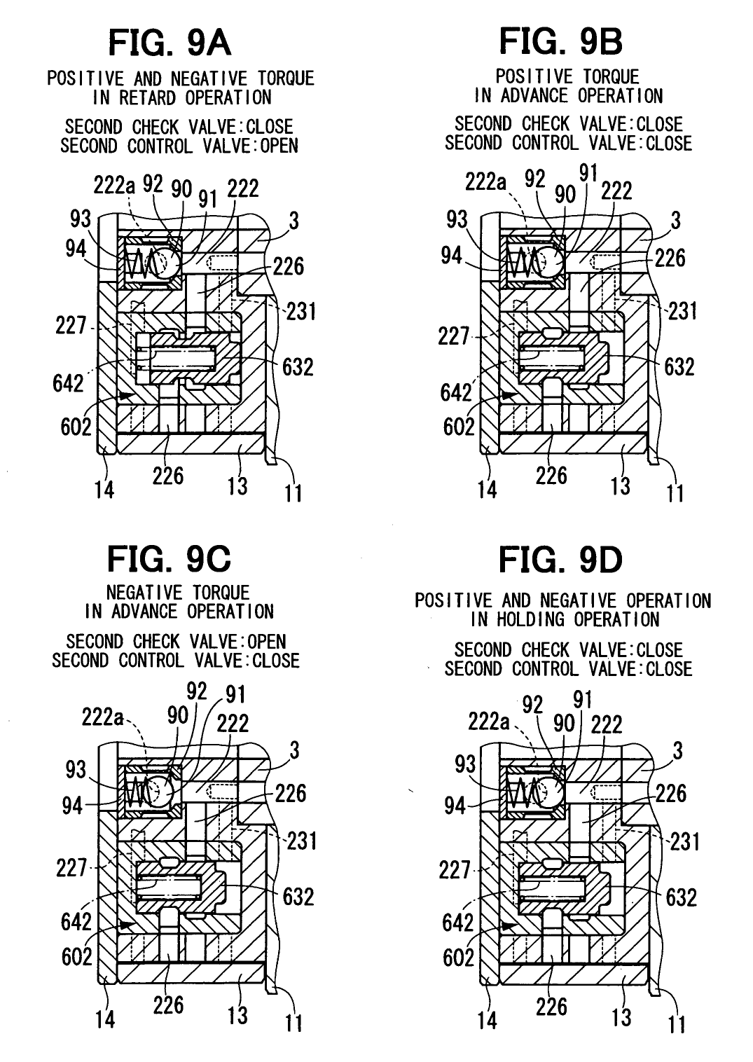

As shown in FIGS. 8A and 9A, the first check valve 80 and the second check valve 90 respectively have valve elements 81, 91, valve seats 82, 92, springs 83, 93, stoppers 84, 94, and the like. The springs 83, 93 are respectively provided between the stoppers 84, 94 and the valve elements 81, 91, thereby respectively applying load to the valve elements 81, 91 toward the valve seats 82, 92.

In the present structure, working fluid is supplied from the hydraulic pump 202 into the retard control chamber 51 or the advance control chamber 55 through the retard passage 212 and the advance passage 222. In this condition, the valve elements 81, 91 respectively move toward the stoppers 84, 94 against the load of the springs 83, 93, and are lifted from the valve seats 82, 92, thereby opening the retard passage 212 or the advance passage 222. Working fluid in the retard passage 212 flows into the retard control chamber 51 through a supply passage 212a (FIGS. 3 and 8) of the retard passage 212. The supply passage 212a communicates the first check valve 80 with the retard control chamber 51. Working fluid in the advance passage 222 flows into the advance control chamber 55 through a supply passage 222a (FIGS. 3 and 9) of the advance passage 222. The supply passage 222a communicates the second check valve 90 with the advance control chamber 55.

Even when working fluid tends to flow from the retard control chamber 51 and the advance control chamber 55 toward the hydraulic pump 202, the retard passage 212 and the advance passage 222 are blocked respectively by the valve elements 81, 91 being biased with the springs 83, 93 onto the valve seats 82, 92.

The first drain passage 225 connects the retard passage 212 on one side of the first check valve 80 with the retard passage 212 on the other side of the first check valve 80 to bypass the first check valve 80 (FIG. 1). A first control valve 601 is provided to the first drain passage 225. The first control valve 601 blocks the first drain passage 225 when a retard control is performed to rotate the vane rotor 15 relatively toward the retard side. The first control valve 601 opens the first drain passage 225 when an advance control is performed to rotate the vane rotor 15 relatively toward the advance side. When the first drain passage 225 is opened, working fluid in the retard control chamber 51 is drained from the first drain passage 225 through the retard passage 212 (FIGS. 3 and 8). Therefore, the first drain passage 225 operates only as a passage for drain. The first drain passage 225 and the second drain passage 226 mentioned later are equivalent to a bypass drain passage.

The first control valve 601 as a drain control valve is a select valve which is operated with pilot pressure. The pilot pressure is applied from the hydraulic pump 202 to the first control valve 601 through the supply passage 204, the retard passage 210, and the retard pilot passage 230. When working fluid is drained from the retard pilot passage 230 and the pilot pressure is not applied to the first control valve 601, a spool 631 as a valve member moves by being biased from a spring 641 as a biasing member, and the first drain passage 225 is opened. Alternatively, when working fluid is supplied into the retard pilot passage 230 and the pilot pressure is applied to the first control valve 601, the spool 631 of the first control valve 601 moves to the position shown in FIG. 1 against load of the spring 641, and the first drain passage 225 is blocked.

The second drain passage 226 connects the advance passage 222 on one side of the second check valve 90 with the advance passage 222 on the other side of the second check valve 90 to bypass the second check valve 90 (FIG. 1). A second control valve 602 is provided to the second drain passage 226. The second control valve 602 blocks the second drain passage 226 when the advance control is performed to rotate the vane rotor 15 relatively toward the advance side. The second control valve 602 opens the second drain passage 226 when the retard control is performed to rotate the vane rotor 15 relatively toward the retard side. When the second drain passage 226 is opened, working fluid in the advance control chamber 55 is drained from the second drain passage 226 through the advance passage 222 (FIGS. 3 and 9). Therefore, the second drain passage 226 operates only as a passage for drain.

The second control valve 602 as a drain control valve is a select valve which is operated with pilot pressure. The pilot pressure is applied from the hydraulic pump 202 to the second control valve 602 through the supply passage 204, the advance passage 220, and the advance pilot passage 231. When working fluid is drained from the advance pilot passage 231 and the pilot pressure is not applied to the second control valve 602, a spool 632 as a valve member moves to the position shown in FIG. 1 by being biased from a spring 642 as a biasing member, and the second drain passage 226 is opened. Alternatively, when working fluid is supplied into the advance pilot passage 231 and the pilot pressure is applied to the second control valve 602, the spool 632 of the second control valve 602 moves against load of the spring 642, and the second drain passage 226 is blocked.

Both the springs 641, 642 apply load respectively to both the spools 631, 632 toward the position where the first drain passage 225 and the second drain passage 226 are opened. Therefore, when pilot pressure is not applied to both the control valves 601 and 602, the first drain passage 225 and the second drain passage 226 are regularly opened. That is, in the present embodiment, the first control valve 601 and the second control valve 602 are normally opened select valves. The vane rotor 15 has a surface on the side of the springs 641, 642 applying force to the spools 631, 632, and the surface has a back pressure vent passage 217, 227 for releasing back pressure changed with sliding of the spool 631, 632.

The retard pilot passage 230 communicates with the retard passage 210. The advance pilot passage 231 communicates with the advance passage 220. The phase select valve 60 switches supply of pilot fluid into one of the first control valve 601 and the second control valve 602 and drain of pilot fluid from the other of the first control valve 601 and the second control valve 602. When the phase select valve 60 is de-energized, the first control valve 601 and the second control valve 602 are in the position depicted in FIG. 1.

Referring to FIG. 2, the second check valve 90 and the second control valve 602 are housed in the vane rotor 15. As being not shown in FIG. 2, the first check valve 80 and the first control valve 601 are also housed in the vane rotor 15 with the same loading structure as those of the second check valve 90 and the second control valve 602. The boss portion 154 of the vane rotor 15 has the retard pilot passage 230 and the advance pilot passage 231.

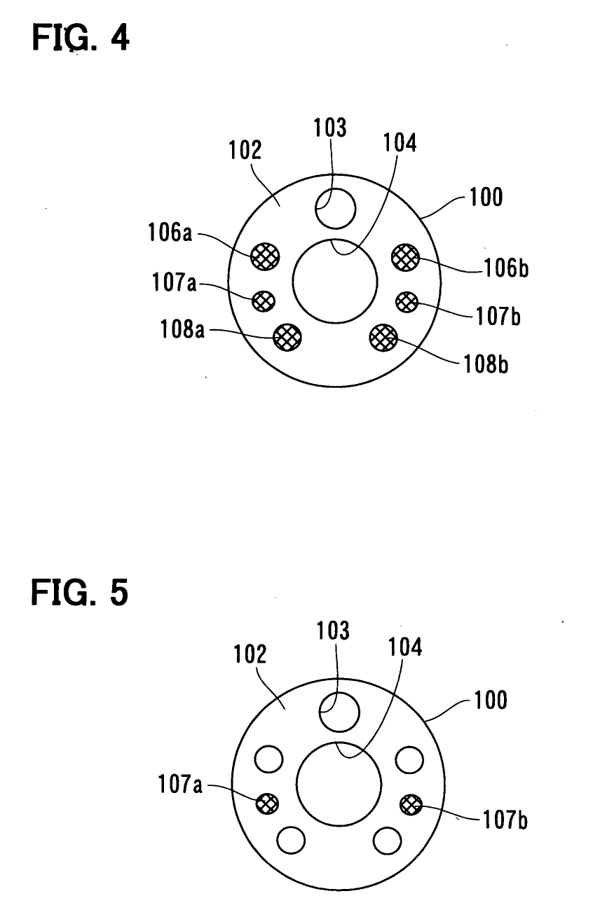

As shown in FIG. 2, a filter 100 is interposed between the axial end surface of the camshaft 3 and the axial end surface of the boss portion 154 of the vane rotor 15, the axial end surface of the camshaft 3 being opposed to the axial end surface of the boss portion 154. That is, the filter 100 is provided on the side of the vane rotor 15 with respect to a slidable portion between the bearing 2 and the camshaft 3. As shown in FIG. 4, the filter 100 is constructed of a support plate 102 and mesh portions 106a, 106b, 107a, 107b, 108a, 108b. The support plate 102 is formed of a metallic thin plate such as a stainless steel plate to be substantially in a disc shape. Each of the mesh portions 106a, 106b, 107a, 107b, 108a, 108b is a metallic mesh, such as a stainless steel mesh, and provided in a through hole of the support plate 102 defining a passage. FIG. 4 is a view showing the filter 100 when viewed from the camshaft 3. The diameter of each of the mesh portions 106a, 106b, 107a, 107b, 108a, 108b is greater than the diameter of each passage. The support plate 102 has through holes 103 and 104 through which the bolt 23 and the locator pin 24 pass. The mesh portion 106a is provided in the advance passage 220. The mesh portion 106b is provided in the retard passage 210. The mesh portion 107a is provided in the retard pilot passage 230. The mesh portion 107b is provided in the advance pilot passage 231. The mesh portion 108a is provided in the retard passage 212. The mesh portion 108b is provided in the advance passage 222.

In the present structure, the mesh portion of the filter 100 is provided in each passage in the connected portion between the camshaft 3 and the vane rotor 15. Thus, foreign matters can be removed from working fluid supplied from the hydraulic pump 202 to the valve timing control apparatus 1. The valve timing control apparatus 1 has a slidable portion between the housing 10 and the vane rotor 15, a slidable portion between the stopper piston 32 and the inner periphery of the vane 153, which accommodates the stopper piston 32. The valve timing control apparatus 1 includes the first check valve 80, the second check valve 90, the first control valve 601, and the second control valve 602 and the like, each having a slidable portion. In the present structure, the slidable portions can be protected from intrusion of foreign matters, thereby being restricted from causing anomalous ablation and malfunction.

In particular, when foreign matters intrude into the retard pilot passage 230 and the advance pilot passage 231, the spools 631, 632 become stuck. In this condition, drain of hydraulic fluid from the advance chamber or the retard chamber cannot be permitted or restricted in the phase control. Therefore, it is desired to provided the mesh portions 107a and 107b in the retard pilot passage 230 and the advance pilot passage 231 to restrict foreign matters from passing through the retard pilot passage 230 and the advance pilot passage 231.

In the present structure, the filter 100 is interposed in the connected portion between the axial end surface of the camshaft 3 and the axial end surface of the boss portion 154 of the vane rotor 15. Therefore, the filter 100 can be mounted between the camshaft 3 and the vane rotor 15, simultaneously with the connecting of the camshaft 3 with the vane rotor 15.

The filter 100 of FIG. 4 may be modified to the filter 100 of FIG. 5, in which the mesh portions 107a, 107b are provided only in positions corresponding to the retard pilot passage 230 and the advance pilot passage 231 to restrict foreign matters from intruding into the retard pilot passage 230 and the advance pilot passage 231.

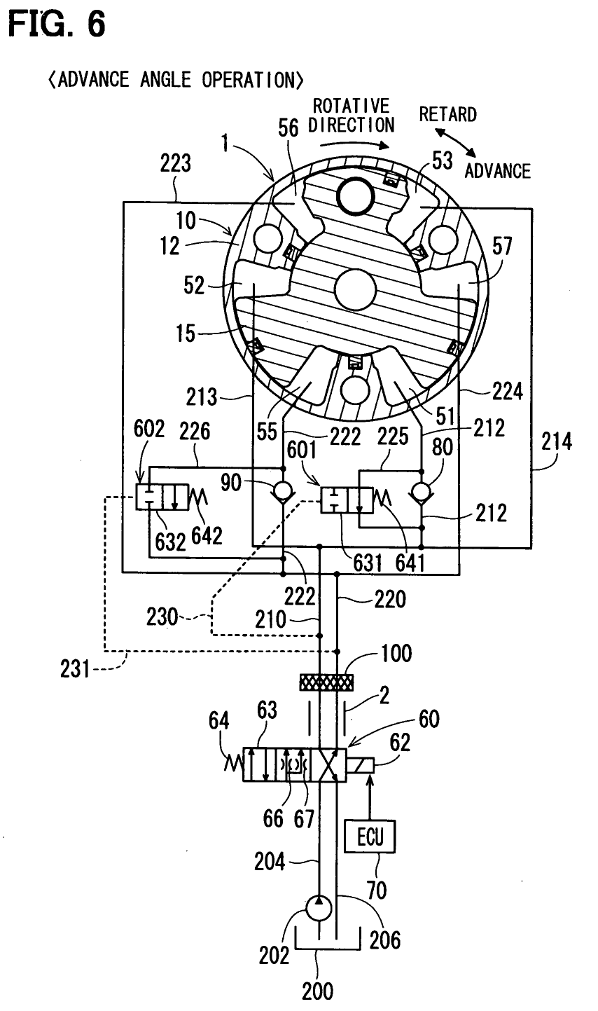

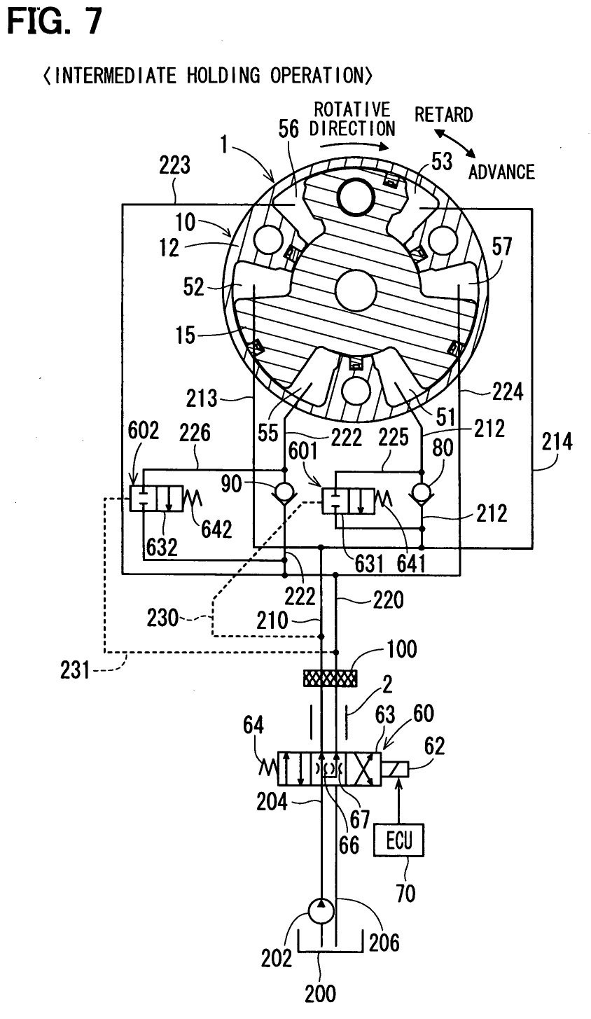

Next, operations of the vane rotor 15 of the valve timing control apparatus 1 and the phase select valve 60 are explained with reference to FIGS. 1, 6, and 7. FIG. 1 shows the vane rotor 15 operated in the retard direction relative to the housing 10. FIG. 6 shows the vane rotor 15 operated in the advance direction relative to the housing 10. FIG. 7 shows the vane rotor 15 being held such that the vane rotor 15 does not rotate relative to the housing 10.

<When Engine is Stopped>

The stopper piston 32 is fitted into the fitting ring 34 when the engine is stopped. The retard chambers 51, 52, 53, the advance chambers 55, 56, 57, the hydraulic pressure chamber 40, and the hydraulic pressure chamber 42 are not sufficiently supplied with working fluid from the hydraulic pump 202 immediately after starting of the engine. In this condition, the stopper piston 32 is fitted into the fitting ring 34, and the camshaft is held in the maximum retard position relative to the crankshaft. The stopper piston 32 restricts collision between the housing 10 and the vane rotor 15, thereby restricts rocking vibration and tap tone caused by torque variation applied to the camshaft, until working fluid is supplied to each hydraulic pressure chamber.

<After Starting of Engine>

After starting of the engine, when the working fluid is sufficiently supplied from the hydraulic pump 202, the stopper piston 32 slips out of the fitting ring 34 by being applied with hydraulic pressure of working fluid supplied to the hydraulic pressure chamber 40 or the hydraulic pressure chamber 42. Thus, the vane rotor 15 becomes rotative relative to the housing 10. The phase difference of the camshaft relative to the crankshaft is controlled by controlling hydraulic pressure applied to each retard chamber and each advance chamber.

<Retard Angle Operation>

Referring to FIG. 1, when the phase select valve 60 is de-energized, the spool 63 is in the position depicted in FIG. 1 by being applied with the load of the spring 64. When the phase select valve 60 is in a changeover state shown in the FIG. 1, the working fluid is supplied from the supply passage 204 to the retard passage 210, and working fluid is drained from the advance passage 220 to the oil sump 200 through the drain passage 206. The pilot pressure is applied to the first control valve 601 through the retard pilot passage 230. The pilot pressure is not applied to the second control valve 602 through the advance pilot passage 231. In this condition, the first control valve 601 and the second control valve 602 are in the changeover state shown in the FIG. 1.

In the changeover state of the phase select valve 60 in the FIG. 1, working fluid is supplied from the retard passage 210 to the retard chambers 52, 53 through the retard passages 213, 214. In addition, in the changeover state of the first control valve 601 and the second control valve 602 in the FIG. 1, working fluid is supplied to the retard chamber 51 through the retard passage 212 through the first check valve 80.

Working fluid in the advance chambers 56, 57 is drained from the advance passages 223, 224 to the oil sump 200 through the advance passage 220, the phase select valve 60, and the drain passage 206. The second check valve 90 is provided in the advance passage 222. Therefore, working fluid in the advance control chamber 55 is drained to the oil sump 200 through the second drain passage 226, the second control valve 602, the advance passages 222, 220, the phase select valve 60, and the drain passage 206.

Thus, the vane rotor 15 receives pressure from working fluid in the three retard chambers 51, 52, 53 by supplying working fluid to each retard chamber and draining working fluid from each advance chamber, thereby the vane rotor 15 rotates to the retard side relative to the housing 10.

Referring to FIG. 1, when the phase control (retard control) is performed to control the phase at a target phase on the retard side, working fluid is supplied to each retard chamber and drained from each advance chamber. In this condition, the vane rotor 15 is exerted with torque fluctuation via the camshaft 3 toward both the retard and advance sides relative to the housing 10. When the vane rotor 15 is exerted with the torque fluctuation to the advance side, working fluid in each retard chamber is exerted with force to flow into the retard passages 212, 213, 214.

In the first embodiment, the first control valve 601 blocks the first drain passage 225 in the retard control, and the first check valve 80 is provided in the retard passage 212. Therefore, working fluid is restricted from flowing out of the retard control chamber 51 into the retard passage 212. Therefore, even when the vane rotor 15 is exerted with torque fluctuation to the advance side in a condition where hydraulic pressure of the hydraulic pump 202 is low, the vane rotor 15 can be restricted from returning to the advance side relative to the housing 10. Consequently, working fluid can be restricted from flowing out of the retard chambers 52, 53. Therefore, even when the vane rotor 15 is exerted with torque fluctuation to the advance side from the camshaft, the vane rotor 15 can be restricted from returning to the advance side opposite to the target phase relative to the housing 10. Thus, the vane rotor 15 can be promptly controlled at the target phase on the retard side.

<Advance Angle Operation>

Next, as shown in FIG. 6, when the phase select valve 60 is energized, the solenoid actuator 62 is applied with electromagnetism to bias the spool 63 against load of the spring 64, and the spool 63 is moved to be in the position shown in FIG. 6. When the phase select valve 60 is in a changeover state shown in the FIG. 6, the working fluid is supplied from the supply passage 204 to the advance passage 220, and working fluid is drained from the retard passage 210 to the oil sump 200 through the drain passage 206. The pilot pressure is not applied to the first control valve 601 through the retard pilot passage 230. The pilot pressure is applied to the second control valve 602 through the advance pilot passage 231. In this condition, the first control valve 601 and the second control valve 602 are in the changeover state shown in the FIG. 6.

In the changeover state of the phase select valve 60 in the FIG. 6, working fluid passes from the supply passage 204 to the advance passage 220, and the working fluid is supplied to the advance chambers 56, 57 through the advance passages 223, 224. In addition, in the changeover state of the first control valve 601 and the second control valve 602 in the FIG. 6, working fluid is supplied to the advance chamber 55 through the advance passage 222 and the second check valve 90.

Working fluid in the retard chambers 52, 53 is drained from the retard passages 213, 214 to the oil sump 200 through the retard passage 210, the phase select valve 60, and the drain passage 206. In the advance control, the first check valve 80 is closed, and the first control valve 601 opens the first drain passage 225. In this condition, working fluid flows out of the retard control chamber 51, and passes through the first drain passage 225, the first control valve 601, and the retard passages 212 by bypassing the first check valve 80. The working fluid further flows to the oil sump 200 after passing through the retard passage 210, the phase select valve 60, and the drain passage 206.

Thus, the vane rotor 15 receives pressure from working fluid in the three advance chambers 55, 56, 57 by supplying working fluid to each advance chamber and draining working fluid from each retard chamber, thereby the vane rotor 15 rotates to the advance side relative to the housing 10.

Referring to FIG. 6, when the phase control (advance control) is performed to control the phase at a target phase on the advance side, working fluid is supplied to each advance chamber and drained from each retard chamber. In this condition, the vane rotor 15 is exerted with torque fluctuation via the camshaft 3 in both the retard and advance sides relative to the housing 10. When the vane rotor 15 is exerted with the torque fluctuation to the retard side, working fluid in each advance chamber is exerted with force to flow into the advance passages 222, 223, 224.

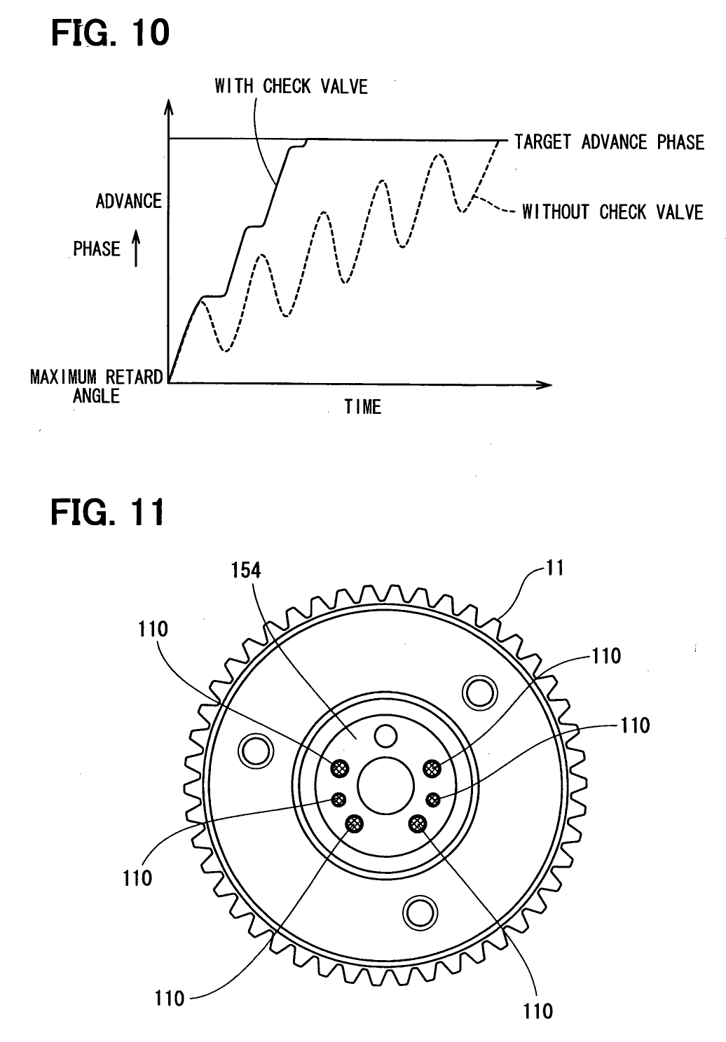

In the first embodiment, the second control valve 602 blocks the second drain passage 226 in the advance control, and the second check valve 90 is provided in the advance passage 222. Therefore, working fluid is restricted from flowing out of the advance control chamber 55 into the advance passage 222. Therefore, even when the vane rotor 15 is exerted with torque fluctuation to the retard side in a condition where hydraulic pressure of the hydraulic pump 202 is low, the vane rotor 15 can be restricted from returning to the retard side relative to the housing 10. Consequently, working fluid can be restricted from flowing out of the advance chambers 56, 57. Therefore, even when the vane rotor 15 is exerted with torque fluctuation to the retard side from the camshaft, the vane rotor 15 can be restricted from returning to the retard side opposite to the target phase relative to the housing 10. Thus, as shown in FIG. 10, the vane rotor 15 can be promptly controlled at the target phase on the advance side.

<Intermediate Holding Operation>

When the vane rotor 15 rotates, and the phase becomes the target phase, the ECU 70 controls the duty ratio of the driving current supplied to the phase select valve 60, and as shown in FIG. 7, the ECU 70 holds the spool 63 at an intermediate position between the positions of FIG. 1 and FIG. 6. In the present state, working fluid is supplied from the supply passage 204 to both the retard passage 210 and the advance passage 220 through throttles 66 and 67, which regulate the flow of working fluid, and the working fluid slightly applies pressure to the retard passage 210 and the advance passage 220.

Here, the throttle 67 has a throttle area greater than a throttle area of the throttle 66. In the state of the phase select valve 60 shown in FIG. 7, an amount of working fluid supplied to the advance passage 220 is greater than an amount of working fluid supplied to the retard passage 210. Therefore, hydraulic pressure in the advance passage 220 and the advance chamber is higher than hydraulic pressure in the retard passage 210 and the retard chamber. When the camshaft 3 drives the intake valve, the camshaft 3 is exerted with torque fluctuation on the retard side on average. The vane rotor 15 is exerted with differential pressure between hydraulic pressure in both the advance passage 220 and the advance chamber and hydraulic pressure in both the retard passage 210 and the retard chamber, so that the vane rotor 15 is biased to the advance side by the differential pressure. The vane rotor 15 is further exerted with an average of the torque fluctuation to the retard side. The vane rotor 15 can be held at the target phase by determining the throttle areas of the throttles 66 and 67 such that the differential pressure exerted to the advance side becomes substantially equal to the average of the torque fluctuation exerted to the retard side.

In present embodiment, since the average of torque fluctuation is exerted to the retard side, the throttle area of the throttle 67 connected to the advance passage 220 is determined to be greater than the throttle area of the throttle 66 connected to the retard passage 210. Meanwhile, when the average of torque fluctuation is midway between the retard side and the advance side, the throttle areas of both the throttles 66, 67 may be determined substantially the same. When the average of torque fluctuation is exerted to the advance side, the throttle area of the throttle 66 connected to the retard passage 210 may be determined greater than the throttle area of the throttle 67 connected to the advance passage 220. Thus, the vane rotor 15 can be held at the target phase.

Working fluid is supplied from the retard passage 210 and the advance passage 220 respectively to the retard pilot passage 230 and the advance pilot passage 231, and pressure of the working fluid is applied to the first control valve 601 and the second control valve 602. Thus, the first control valve 601 and the second control valve 602 are held at the changeover state shown in FIG. 7. Thereby, both the first drain passage 225 and the second drain passage 226 are blocked, and working fluid is restricted from being drained from the retard chamber 51 and the advance chamber 56 through the first drain passage 225 and the second drain passage 226.

Next, operations of the first check valve 80, the second check valve 90, the first control valve 601, and the second control valve 602 are described with reference to FIGS. 8A to 9D in the retard angle operation, the intermediate holding operation, and the advance angle operation. FIGS. 8A to 8D show operations of the first check valve 80 connected to the retard control chamber 51 and the first control valve 601. FIGS. 9A to 9D show operations of the second check valve 90 connected to the advance control chamber 55 and the second control valve 602.

<Retard Angle Operation>

In the retard control, the second control valve 602 and the phase select valve 60 are in the changeover state where working fluid is drained from each advance chamber. Therefore, as shown in FIG. 9A, the second check valve 90 blocks the advance passage 222, and restricts couterflow from the supply passage 222a to the advance passage 222, regardless of whether torque fluctuation exerted to the vane rotor 15 is advance torque (negative torque) or retard torque (positive torque) in the retard control. The second control valve 602 opens the second drain passage 226 by being exerted with load of the spring 642, and enables working fluid flowing from the advance control chamber 55 through the second drain passage 226.

The working fluid is supplied from the retard passage 210 to the retard passages 212, 213, 214 in the retard control. Therefore, when the vane rotor 15 is not exerted with positive or negative torque fluctuation, the first check valve 80 opens the retard passage 212, and working fluid is supplied from the retard passage 212 to the retard control chamber 51 through the supply passage 212a.

When the vane rotor 15 is exerted with torque fluctuation (positive torque) to the retard side in the retard control, as shown in FIG. 8A, the first check valve 80 also opens the retard passage 212. The first control valve 601 blocks the first drain passage 225 by being applied with the pilot pressure, and restricts working fluid from flowing from the retard control chamber 51 through the first drain passage 225.

As shown in FIG. 8B, when the vane rotor 15 is exerted with negative torque to the advance side in the retard control, the first check valve 80 blocks the retard passage 212, and restricts a couterflow from the supply passage 212a to the retard passage 212. The first control valve 601 holds blocking the first drain passage 225 by being applied with the pilot pressure, and restricts working fluid from flowing from the retard control chamber 51 through the first drain passage 225.

<Advance Angle Operation>

In the advance control, the first control valve 601 and the phase select valve 60 are in the changeover state where working fluid is drained from each retard chamber. Therefore, as shown in FIG. 8C, the first check valve 80 blocks the retard passage 212, and restricts couterflow from the supply passage 212a to the retard passage 212, regardless of whether torque fluctuation exerted to the vane rotor 15 is advance torque or retard torque in the advance control. The first control valve 601 opens the first drain passage 225 by being exerted with load of the spring 641, and enables working fluid flowing from the retard control chamber 51 through the first drain passage 225.

The working fluid is supplied from the advance passage 220 to the advance passages 222, 223, 224 in the advance control. Therefore, when the vane rotor 15 is not exerted with positive or negative torque fluctuation, the second check valve 90 opens the advance passage 222, and working fluid is supplied from the advance passage 222 to the advance control chamber 55 through the supply passage 222a.

When the vane rotor 15 is exerted with torque fluctuation (negative torque) to the advance side in the advance control, as shown in FIG. 9C, the second check valve 90 also opens the advance passage 222. The second control valve 602 blocks the second drain passage 226 by being applied with the pilot pressure, and restricts working fluid from flowing from the advance control chamber 55 through the second drain passage 226.

As shown in FIG. 9B, when the vane rotor 15 is exerted with positive torque to the retard side in the advance control, the second check valve 90 blocks the advance passage 222, and restricts a couterflow from the supply passage 222a to the advance passage 222. The second control valve 602 holds blocking the second drain passage 226 by being applied with the pilot pressure, and restricts working fluid from flowing from the advance control chamber 55 through the second drain passage 226.

<Intermediate Holding Operation>

As shown in FIG. 9D, when the vane rotor 15 is exerted with positive torque or negative torque in the intermediate holding operation, the second check valve 90 blocks the advance passage 222, and restricts a couterflow from the supply passage 222a to the advance passage 222. The second control valve 602 blocks the second drain passage 226 by being applied with the pilot pressure against the load of the spring 642, and restricts working fluid from flowing from the advance control chamber 55 through the second drain passage 226.

As shown in FIG. 8D, when the vane rotor 15 is exerted with positive torque or negative torque in the intermediate holding operation, the first check valve 80 blocks the retard passage 212, and restricts a couterflow from the supply passage 212a to the retard passage 212. The first control valve 601 blocks the first drain passage 225 by being applied with the pilot pressure against the load of the spring 641, and restricts working fluid from flowing from the retard control chamber 51 through the first drain passage 225.

According to the first embodiment, the first check valve 80 is provided in the retard passage 212, and the second check valve 90 is provided in the advance passage 222. The first control valve 601 blocks the first drain passage 225, and the second control valve 602 blocks the second drain passage 226 in the intermediate holding operation. Therefore, even when the vane rotor 15 is exerted with torque fluctuation to both the retard side and the advance side in the intermediate holding operation where the vane rotor 15 is held at the target phase, hydraulic fluid can be restricted from flowing out of both the retard control chamber 51 and the advance control chamber 55. Therefore, even when the vane rotor 15 is exerted with torque fluctuation to both the retard side and the advance side in the intermediate holding operation, the vane rotor 15 can be restricted from returning to both the retard side and the advance side relative to the housing 10. Consequently, working fluid can be restricted from flowing out of all the retard chambers 52, 53 and the advance chambers 56, 57. Therefore, the vane rotor 15 can be restricted from rotating to both the retard side and the advance side relative to the housing 10 in the intermediate holding operation. Thus, deviation in the valve timing of the intake valve can be restricted.

### Second Embodiment

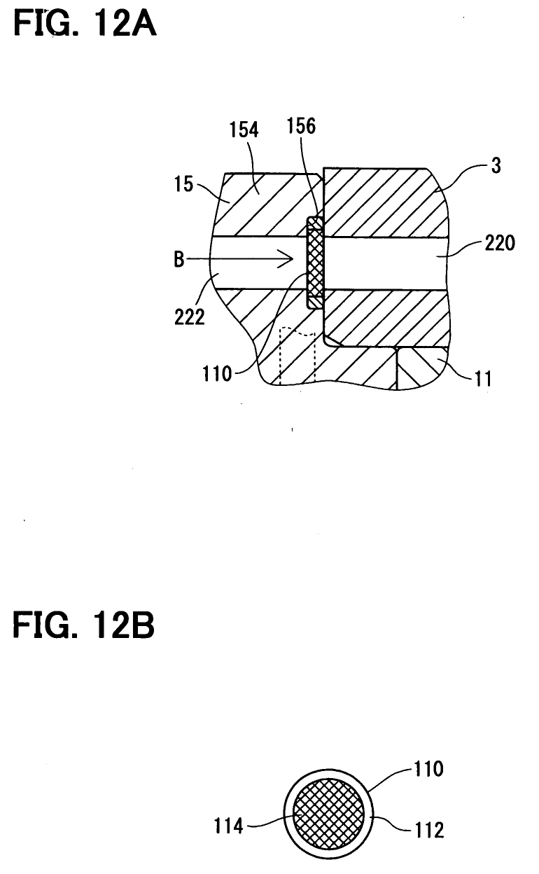

The second embodiment is described with reference to FIGS. 11 and 12. According to the first embodiment, the single filter 100 is used for removing foreign matters from the multiple passages. By contrast, in the second embodiment, as shown in FIG. 11, filters 110 including separate members are provided respectively to the passages. FIG. 11 is a view showing the valve timing control apparatus when being viewed from the camshaft 3. Specifically, as shown in FIGS. 12A, 12B, the boss portion 154 of the vane rotor 15 has an axial end surface opposed to the camshaft 3, and the axial end surface has circumferences each defining a passage and having an annular recess 156. Each recess 156 is located in the connected portion between the vane rotor 15 and the camshaft 3, and is fitted with one of the filters 110. The recess fitted with the filter 110 may be provided in an axial end surface of the camshaft 3 opposed to the boss portion 154, instead of being provided to the axial end surface of the vane rotor 15.

The filter 110 includes an annular supporting member 112 and a mesh portion 114. The annular supporting member 112 is formed of resin or metal such as stainless steel. The mesh portion 114 is formed of metal such as stainless steel, and is provided inside the annular supporting member 112.

According to the second embodiment, the filters 110 are provided in all the passages in the connected portion between the vane rotor 15 and the camshaft 3. Alternatively, the filters 110 may be provided only in specific passages such as the retard pilot passage 230 the advance pilot passage 231.

The filters 110 are not limited to being provided at multiple passages, and one filter 110 may be provided at one passage.

### Other Embodiment

According to the above embodiments, the filter is provided in the connected portion between the camshaft 3 and the vane rotor 15 for removing foreign matters from working fluid. Alternatively, the filter may be provided at any locations as long as being located on the side of the housing 10 and the vane rotor 15 with respect to the slidable portion between the bearing 2 and the camshaft 3. For example, the filter may be provided in a passage end directly before working fluid flows into the retard chamber and the advance chamber.

In the above embodiments, the first check valve 80 and the second check valve 90 are provided respectively to the retard chamber 51 and the advance chamber 55. In addition, the first control valve 601 and the second control valve 602 are provided respectively to the retard chamber 51 and the advance chamber 55. Alternatively, the check valve and the drain control valve may be provided to either the retard chamber or the advance chamber. Alternatively, both the check valve and the drain control valve may be omitted.

In the above embodiments, the first check valve 80 is provided only in the retard passage 212 among the multiple retard passages 212, 213, 214. Alternatively, the first check valve 80 is not limited to being provided only in the retard passage 212, and may be provided in at least one of the multiple retard passages 212, 213, 214. For example, the first check valve 80 may be provided to each of the multiple retard passages 212, 213, 214.

In the above embodiments, the second check valve 90 is provided only in the advance passage 222 among the multiple advance passages 222, 223, 224. Alternatively, the second check valve 90 is not limited to being provided only in the advance passage 222, and may be provided to at least one of the multiple advance passages 222, 223, 224. For example, the second check valve 90 may be provided to each of the multiple advance passages 222, 223, 224.

In the above embodiments, the retard pilot passage 230 and the advance pilot passage 231 branch respectively from the retard passage 210, which connects the phase select valve 60 with the retard chambers, and the advance passage 220, which connects the phase select valve 60 with the advance chambers. Alternatively, the retard pilot passage 230 and the advance pilot passage 231 may be provided separately from the retard passage 210, the advance passage 220, and the hydraulic pump 202. In this case, a select valve may be provided for changeover of supply and drain of working fluid to control application of hydraulic pressure to the first control valve 601 and the second control valve 602 through the retard pilot passage 230 and the advance pilot passage 231. In this structure, the retard pilot passage 230 and the advance pilot passage 231 may be also formed in the vane rotor 15, and may be also defined to pass through the slidable portion between the bearing 2 and the camshaft 3, the interior of the camshaft 3, and the connected portion between the camshaft 3 and the vane rotor 15.

In the restriction mechanism of the above embodiments, rotation of the vane rotor 15 relative to the housing 10 is restricted by fitting the stopper piston 32 into the fitting ring 34. Alternatively, such a restriction mechanism may be omitted.

In the above embodiments, the chain sprocket may be substituted by a transmission mechanism including a cam pulley, a timing gear, and the like for transmitting driving force of the crankshaft to the camshaft. The driving force of the crankshaft may be exerted to the vane rotor so as to rotate the camshaft integrally with the housing.

The above embodiments are not limited to being applied to the valve timing control apparatus for manipulating the intake valve. The above embodiments may be applied to a valve timing control apparatus for controlling a valve timing of at least one of the exhaust valve and the intake valve. That is, the above structure in the above embodiments may be applied to a valve timing control apparatus adapted to controlling either a valve timing of the exhaust valve or a valve timing of the intake valve, and may be applied to a valve timing control apparatus adapted to controlling both the exhaust valve and the intake valve. The filter may be provided to a connected portion between the camshaft and the housing.

In this manner, the invention is not limited to the embodiments described above but is applicable to various embodiments within a scope not departing from the gist thereof. For example, features of the above embodiments may be arbitrary combined.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. A valve timing control apparatus provided in a driving force transmission system for transmitting driving force from a driving shaft of an internal combustion engine to a driven shaft for manipulating at least one of an intake valve and an exhaust valve, the apparatus being adapted to controlling an opening timing and a closing timing of at least one of the intake valve and the exhaust valve, the apparatus comprising:
a housing adapted to being rotated with one of the driving shaft and the driven shaft, the housing having a chamber house in a predetermined angle range relative to a rotative direction;
a vane rotor having a vane accommodated in the chamber house and partitioning the chamber house into a retard chamber and a advance chamber, the vane rotor being rotative in conjunction with an other of the driving shaft and the driven shaft to a retard side and an advance side relative to the housing by being exerted with hydraulic pressure in the retard chamber and the advance chamber; and
a filter provided for removing foreign matters in a fluid passage,
wherein the fluid passage is adapted to leading hydraulic fluid from a slidable portion between the driven shaft and a bearing of the driven shaft to both the housing and the vane rotor through a connected portion between the driven shaft and one of the housing and the vane rotor, and
the filter is provided on a side of both the housing and the vane rotor with respect to the slidable portion.

2. The valve timing control apparatus according to claim 1, wherein the filter is located in the fluid passage on the side of both the housing and the vane rotor with respect to the connected portion.

3. The valve timing control apparatus according to claim 2, wherein the filter is located in the connected portion.

4. The valve timing control apparatus according to claim 1, further comprising:
a fitting member supported by one of the housing and the vane rotor, and is movable by being exerted with hydraulic pressure in the fluid passage,
wherein the fitting member restricts rotation of the vane rotor relative to the housing when being fitted to the fitting hole of an other of the housing and the vane rotor.

5. The valve timing control apparatus according to claim 1, further comprising:
a check valve provided to at least one of a retard passage, which connects a fluid source with the retard chamber, and an advance passage, which connects the fluid source with the advance chamber, the check valve is connected with one of the retard chamber and the advance chamber, and is adapted to regulating a flow of hydraulic fluid from the one of the retard chamber and the advance chamber to the fluid source, the check valve permitting a flow of hydraulic fluid from the fluid source to the one of the retard chamber and the advance chamber; and
a control valve provided in a bypass drain passage being provided to the one of the retard chamber and the advance chamber separately from both the retard passage and the advance passage for draining hydraulic fluid from the one of the retard chamber and the advance chamber,
wherein the control valve is operated when being exerted with pilot pressure from hydraulic fluid supplied from the fluid source through a pilot passage,
the control valve blocks the bypass drain passage when hydraulic fluid is supplied from the fluid source to the one of the retard chamber and the advance chamber to rotate the vane rotor to one of the retard side and the advance side relative to the housing, and
the control valve opens the bypass drain passage when hydraulic fluid is drained from the one of the retard chamber and the advance chamber to rotate the vane rotor to an other of the retard side and the advance side relative to the housing.

6. The valve timing control apparatus according to claim 5, wherein the filter is provided to the advance passage, the retard passage, and the pilot passage.

7. The valve timing control apparatus according to claim 5, wherein the filter is provided to the pilot passage.

8. The valve timing control apparatus according to claim 5,
wherein the connected portion is defined by a first end surface of the driven shaft and a second end surface of the one of the housing and the vane rotor,
at least one of the first end surface and the second end surface has a recess defined around at least one of the advance passage, the retard passage, and the pilot passage, and
the filter is provided to the recess.

9. The valve timing control apparatus according to claim 5,
wherein the check valve includes a valve element, a valve seat, and a first biasing member,
the first biasing member applies load to the valve element toward the valve seat to regulate the flow of hydraulic fluid from the one of the retard chamber and the advance chamber,
the control valve includes a valve member and a second biasing member,
the valve member is movable against load of the second biasing member by being exerted with the pilot pressure to open and close the bypass drain passage, and
the filer is located on the side of the check valve and the control valve with respect to the sliding portion.

10. The valve timing control apparatus according to claim 5, wherein the fluid passage includes the advance passage, the retard passage, and the pilot passage.
